(19) United States
(12) Patent Application Publication
(10) Pub. No.: US 2025/0083516 A1
(43) Pub. Date: Mar. 13, 2025

(54) Electric Drive for a Vehicle

(71) Applicant: ZF Friedrichshafen AG, Friedrichshafen (DE)

(72) Inventors: Jürgen WAFZIG, Bermatingen (DE); Matthias REISCH, Ravensburg (DE)

(21) Appl. No.: 18/292,494

(22) PCT Filed: Jul. 21, 2022
(86) PCT No.: PCT/EP2022/070468

§ 371 Date: Jan. 26, 2024

(30) Foreign Application Priority Data
Jul. 26, 2021 (DE) 10 2021 207 998.9

(51) Int. Cl. B60K 17/16; B60K 17/12; F16H 63/32

(52) U.S. Cl. CPC B60K 17/165; B60K 17/12; F16H 2063/324

(57) ABSTRACT

An electric drive for a vehicle includes at least one electric machine (1) with a rotor shaft (2) as a drive shaft, a transmission connected to a first output shaft (3) and a second output shaft (4), and a shift element (5) with at least one actuatable coupling element for achieving a first shift position (N), a second shift position (S2) and a third shift position (S2). In the first shift position (N), the coupling element is connected either to an element of the transmission or to the rotor shaft (2). In the second shift position (S1), the element of the transmission is connected to the rotor shaft (2) via the coupling element. In the third shift position (S2), the element of the transmission and the rotor shaft (2) are connected to the housing via the coupling element.

### CROSS-REFERENCE TO RELATED APPLICATIONS

The present application is related is a U.S. national phase application of PCT/EP2022/070468 filed on Jul. 21, 2022 and has right of priority to German Patent Application No. DE102021207998.9 filed on Jul. 26, 2021, both of which are incorporated by reference in their entirety for all purposes.

### TECHNICAL FIELD

The present invention relates generally to an electric drive for a vehicle, the electric drive including at least one electric machine with a rotor shaft as a drive shaft, including a transmission which is connected to a first output shaft and a second output shaft, and including a shift element with at least one actuatable coupling element for achieving a first shift position, a second shift position and a third shift position. The invention further relates generally to a vehicle having at least one electric drive.

### BACKGROUND

A drive unit for an electrically driven vehicle is known, for example, from document DE 10 2018 211 113 A1. The drive unit includes an electric motor which transmits a drive torque by a drive shaft onto a vehicle wheel which is connected to an output shaft. An engaging and disengaging clutch is provided between the drive shaft and the output shaft. Furthermore, a parking lock which acts on the output shaft is provided for holding the vehicle at a standstill. The clutch has three shift positions. In a first shift position, the output shaft is coupled to the drive shaft. In a third shift position, the output shaft is decoupled from the drive shaft and the output shaft is blockable with respect to rotation by a locking element. In a second shift position, the output shaft is decoupled both with respect to the drive shaft and with respect to the locking element. This results in the disadvantage that considerable actuating forces are necessary to engage and disengage the third shift position when the output is blocked, due to the loads acting on the shift element. In addition, undesirable comfort-reducing and component-loading impacts arise.

### BRIEF SUMMARY

Example aspects of the present invention provide an electric drive and a vehicle having the drive, in which the loads that occur on the shift element are as low as possible.

Example aspect of the invention relate to an electric drive for a vehicle, the electric drive including at least one electric machine with a rotor shaft as a drive shaft, including a transmission which is connected to a first output shaft and a second output shaft, and including a shift element or the like with at least one actuatable coupling element for achieving a first shift position, a second shift position and a third shift position. In order to achieve gear shifts which are as comfortable as possible using the lowest possible shifting forces, according to example aspects of the invention, in the first shift position the coupling element is connected either to an element of the transmission or to the rotor shaft, in the second shift position the element of the transmission is connected to the rotor shaft via the coupling element and in the third shift position the element of the transmission and the rotor shaft are connected to the housing via the coupling element or are connected to the housing.

In this way, it is possible by the drive according to example aspects of the invention to not only decouple the output to implement the disconnect function, but also to implement a parking lock function with the lowest possible shifting forces and thus with a shift element having correspondingly small dimensions. Due to the fact that, in particular, both the drive and the output are coupled to the housing when the parking lock function is activated, the advantage results that synchronization can take place during the engagement and disengagement of this shift position by the connected electric machine and thus the applied load is reduced, as a result of which component-loading impacts are prevented and the ease of gear changes is increased.

Accordingly, an engaging and disengaging connection is established between three elements, specifically the electric machine, the transmission and the output shafts, and the housing using only one shift element. The shift element is designed more or less as a double shift element, in which a neutral position for decoupling the output in order to reduce drag losses and two further shift positions are achieved. The shift element can be in the form of a constant-mesh shift element or a synchronizer. The shift positions are interchangeable binomially with the coupling of the drive, the decoupling of the drive and the connection which is fixed to the housing. For example, it is also conceivable that one of the shift positions of the shift element can be held by a machine element, for example by a spring, in situations without actuating energy.

Preferably, in the drive according to example aspects of the invention, an economical interlocking shift element in the form of a shifting dog having an axially displaceable sliding sleeve in the form of a coupling element can be used, which is movable into the shift positions situated one behind the other in an axial direction via a selector fork which is actuatable via a spindle drive. Other types of actuation are also conceivable. Preferably, an electromechanical, pneumatic or hydraulic drive can be provided for actuating the coupling element. The coupling element can be one-piece or multi-piece in order, for example, to prevent high sliding forces under torque.

An arrangement of the drive which is space-saving particularly in the radial direction is achieved by arranging the rotor shaft and the transmission as well as the output shafts coaxially.

The advantageous example elimination of an additional output differential in the drive is achieved by providing, for example, a first planetary gear set and a second planetary gear set as the transmission, the planetary gear sets being coupled to one another such that the torque introduced via the rotor shaft is splittable onto a first output shaft and a second output shaft via the planetary gear sets.

For example, in order to couple the two planetary gear sets, a ring gear of the first planetary gear set can be connected to the second output shaft, a planet carrier of the first planetary gear set can be connected to a housing, a sun gear of the first planetary gear set can be connected to a ring gear of the second planetary gear set, a planet carrier of the second planetary gear set can be connected to the first output shaft, and a sun gear of the second planetary gear set can be connectable to the rotor shaft and/or to the housing via the shift element.

The two planetary gear sets are therefore coupled between the sun gear of the first planetary gear set and the ring gear of the second planetary gear set. For this purpose, for example, a coupling shaft can be used when the planetary gear sets are arranged axially next to one another. When the planetary gear sets have a radially nested design, it is advantageous that the sun gear and the ring gear are formed as one component having external toothing and internal toothing.

Accordingly, the two planetary gear sets can be radially nested or even arranged axially next to each other depending on the design in order to therefore reduce either axial or radial installation space depending on the area of application. For example, negative planetary gear sets or even positive planetary gear sets can be used in the drive.

A negative planetary gear set has planet gears which are rotatably mounted on the planet carrier and intermesh with the sun gear and the ring gear of this planetary gear set, such that, when the planet carrier is held and the sun gear rotates, the ring gear rotates in the direction of rotation counter to the direction of rotation of the sun gear. By comparison, a positive planetary gear set has inner and outer planet gears which are rotatably mounted on the planet carrier and are in tooth engagement with one another, wherein the sun gear of this planetary gear set intermeshes with the inner planet gears, and the ring gear of this planetary gear set intermeshes with the outer planet gears, such that, when the planet carrier is held and the sun gear rotates, the ring gear rotates in the same direction of rotation as the sun gear. A negative planetary gear set can preferably be transferred into a positive planetary gear set when the planet carrier connection and the ring gear connection to this gear set are interchanged with one another and the value of the stationary transmission ratio is increased by one (1).

Example aspects of the invention also provide a vehicle having at least one electric drive. This yields the above-described example advantages and further advantages. In particular, the electric drive can also be in the form of an axle drive, wherein the vehicle can then include, for example, multiple axle drives which are advantageously shiftable independently of one another.

### BRIEF DESCRIPTION OF THE DRAWINGS

Example aspects of the present invention are explained in greater detail in the following with reference to the drawings, wherein:

FIGS. 1A through 1C show a schematic view of a first example embodiment of a coupling element of a shift element of an electric drive according to example aspects of the invention in various shift positions;

FIGS. 2A through 2C show a schematic view of a second example embodiment of the coupling element of the shift element of the electric drive according to example aspects of the invention in various shift positions;

FIG. 3 shows a schematic view of the electric drive in a first shift position N;

FIG. 4 shows a schematic view of the electric drive in a second shift position S1;

FIG. 5 shows a schematic view of the electric drive in a third shift position S2;

FIG. 6 shows a cut view of the electric drive in the first shift position N;

FIG. 7 shows a cut view of the electric drive in the second shift position S1;

FIG. 8 shows a cut view of the electric drive in the third shift position S2; shows a schematic view of the electric drive with radially nested FIG. 9 planetary gear sets;

FIG. 10 shows a schematic view of the electric drive with radially nested planetary gear sets with an alternative arrangement of the shift element;

FIG. 11 shows a schematic view of the electric drive with planetary gear sets arranged axially next to one another; and

FIG. 12 shows a schematic view of the electric drive with planetary gear sets arranged axially next to one another with an alternative arrangement of the shift element.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

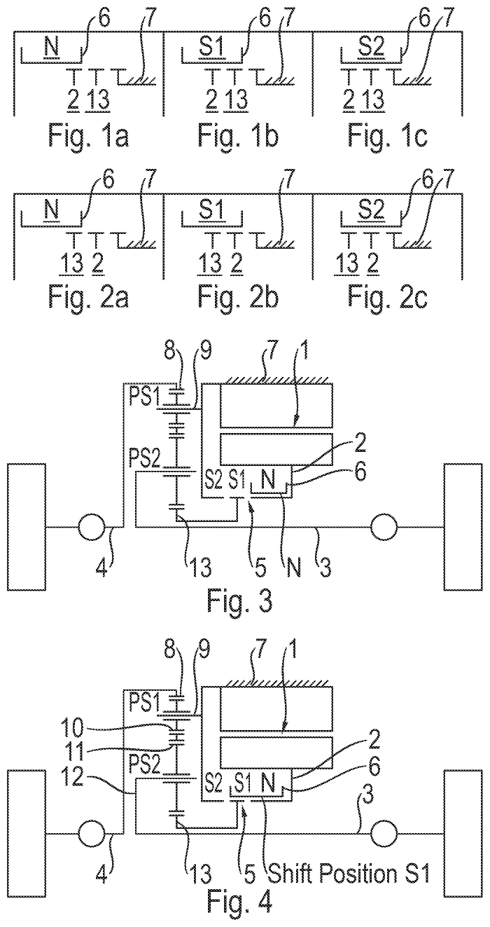

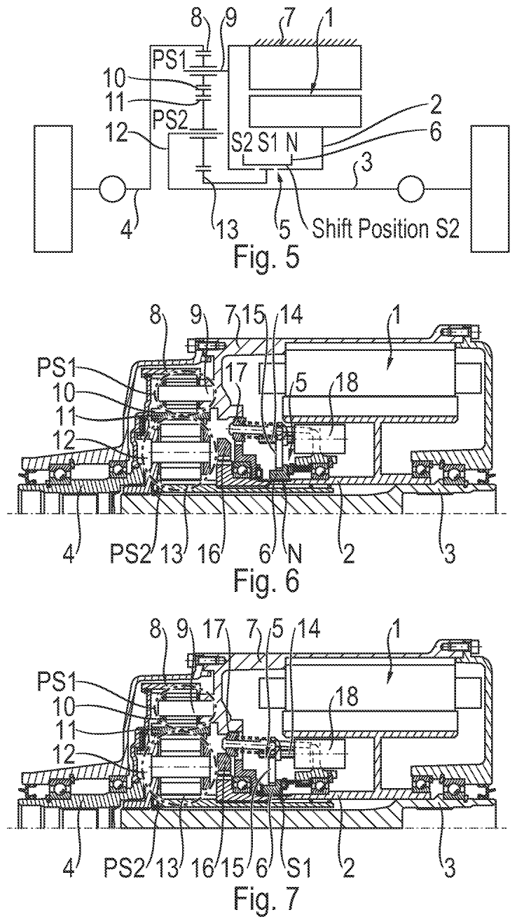

FIGS. 1 through 12 show, by way of example, an electric drive for a vehicle with reference to various views and example embodiments.

Regardless of the various example embodiments, the electric drive, as an axle drive, by way of example, includes an electric machine 1 with a rotor shaft 2 as a drive shaft and a transmission with a first planetary gear set PS1 and a second planetary gear set PS2, which are coupled to each other such that the torque applied by the electric machine 1 is split onto a first output shaft 3 and a second output shaft 4. The electric drive further includes a shift element 5 with at least one coupling element, which is in the form of an axially displaceable sliding sleeve 6, for achieving a first shift position N, a second shift position S1, and a third shift position S2. The shift element 5, which is in the form of an electromechanical actuator, by way of example, includes an electric motor 18 which moves a selector fork 15 via a spindle drive 14, the selector fork 15 being operatively connected in turn to the sliding sleeve 6, such that the sliding sleeve 6 can be moved axially between the shift positions N, S1, S2. The rotor shaft 2 and the transmission or the two planetary gear sets PS1, PS2 and the output shafts 3, 4 are coaxial.

In the first shift position N, the coupling element or the sliding sleeve 6 is connected either to an element of the planetary gear sets PS1, PS2 or to the rotor shaft 2 depending on the example embodiment. This first shift position N is referred to as neutral or disconnect, which permits passive driving of the vehicle, in which the axle drive is decoupled from the vehicle wheels in order to reduce drag torques.

In the second shift position S1, the element of the planetary gear sets PS1, PS2 is connected to the rotor shaft 2 via the sliding sleeve 6. This second shift position S1 is referred to as connect, which permits active driving of the vehicle, in which the electric machine 1, as the prime mover, is connected to the output shafts 3, 4 via the planetary gear sets PS1, PS2.

In the third shift position S2, the element of the planetary gear sets PS1, PS2 and the rotor shaft 2 are connected to the housing 7 or the stator of the electric machine 1 via the sliding sleeve 6. This third shift position S2 is referred to as park, in which the vehicle is not movable, since the parking lock has been engaged or activated.

These various coupling states or shift positions N, S1, S2 are schematically shown with reference to a first example embodiment in FIGS. 1A through 1C and with reference to a second example embodiment in FIGS. 2A through 2C.

FIGS. 1A and 2A each show the first shift position N for passive driving or for the activated disconnection function. In the first example embodiment according to FIG. 1A, in the first shift position N, the sliding sleeve 6 of the shift element 5 is connected to the rotor shaft 2 and in the second example embodiment according to FIG. 2A, the sliding sleeve 6 of the shift element 5 is connected to a sun gear 13 as the element of the second planetary gear set PS2.

FIGS. 1B and 2B each show the second shift position S1 for active driving. In both the first example embodiment according to FIGS. 1B and 1n the second example embodiment according to FIG. 2B, in the second shift position S1, the rotor shaft 2 is connected for driving via the sliding sleeve 6 to the sun gear 13 as the element of the second planetary gear set PS2.

FIGS. 1C and 2C each show the third shift position S2 for parking the vehicle. In both the first example embodiment according to FIGS. 1C and 1n the second example embodiment according to FIG. 2C, in the third shift position S2, the rotor shaft 2 and the sun gear 13, as the element of the second planetary gear set PS2, are connected to the housing 7 via the sliding sleeve 6. Accordingly, the parking lock is activated or engaged.

FIGS. 3 through 12 show further views of the electric drive by way of example. From these views it becomes clear that a ring gear 8 of the first planetary gear set PS1 is connected to the second output shaft 4, that a planet carrier 9 of the first planetary gear set PS1 is connected to the housing 7 as a fixed housing connection, that a sun gear 10 of the first planetary gear set PS1 is connected to a ring gear 11 of the second planetary gear set PS2 as one component having internal and external toothing for coupling the two planetary gear sets PS1 and PS2, that a planet carrier 12 of the second planetary gear set PS2 is connected to the first output shaft 3 and that the sun gear 13, as an element of the second planetary gear set PS2, is connectable via the sliding sleeve 6 of the shift element 5 to the rotor shaft 2 in the second shift position S1 or to the rotor shaft 2 and to the housing 7 in the third shift position S2. In the first shift position, the sun gear 13 of the second planetary gear set PS2 is not connected to the drive.

FIGS. 3 through 5 show the electric drive by way of example in the three shift positions N, S1, S2. The first shift position N is shown in FIG. 3, in which the rotor shaft 2 is connected to the sliding sleeve 6. The second shift position S1 is shown in FIG. 4, in which the sun gear 13 of the second planetary gear set PS2 is drivingly connected to the rotor shaft 2 of the electric machine 1 via the sliding sleeve 6. The third shift position S2 is shown in FIG. 5, in which the sun gear 13 of the second planetary gear set PS2 is connected both to the rotor shaft 2 and to the housing 7 or to the stator via the sliding sleeve 6.

FIGS. 6 through 8 also show the electric drive in the three shift positions N, S1, S2, although these views are sectional views. In particular, the electromechanical actuator or the shift element 5 including components of the shift element 5 are apparent in these sectional views. The shift element 5 includes an electric motor 18 which drives a spindle drive 14 with which a selector fork 15 is actuated in order to displace the sliding sleeve 6 axially between the shift positions N, S1, S2. By the selector fork 15, a locking element 17 for locking or releasing a parking pawl 16 is provided via a machine element, for example, a rod or a pin. In the third shift position S2, this locking element 17 is brought into an operative connection with the parking pawl 16 such that the parking pawl 16 connects the sun gear 13 to the housing 7, such that the parking lock in the vehicle is engaged or activated and thus the output is blocked.

FIGS. 9 through 12 show various example embodiments of the planetary gear sets and of the shift element 5 with respect to the electric machine 1 by way of example.

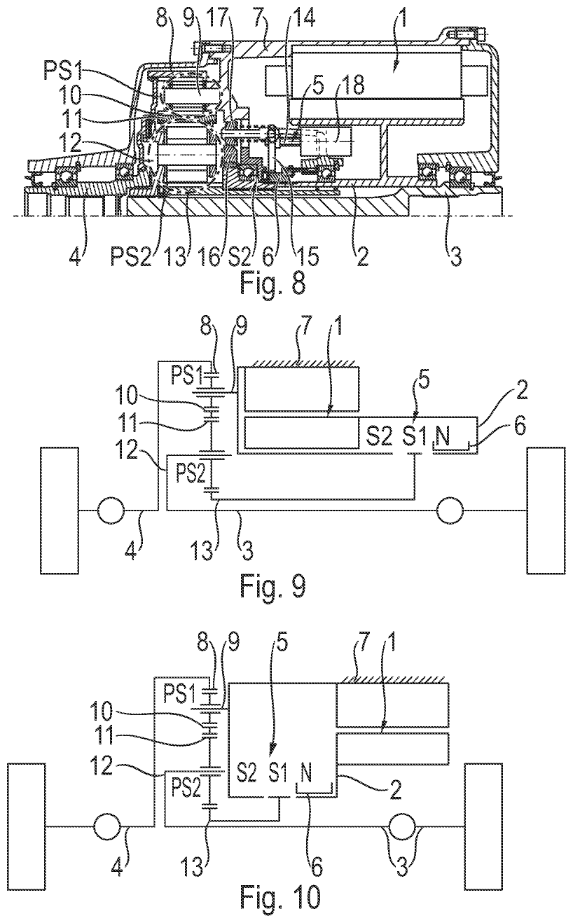

In FIGS. 9 and 10, the planetary gear sets PS1, PS2 are radially nested. This means, the second planetary gear set PS2, viewed radially, is arranged within the first planetary gear set PS1. It is also conceivable that the arrangement is interchanged. In addition, FIG. 9 shows that the shift element 5 including components of the shift element 5, viewed axially, is arranged on the side of the electric machine 1 facing away from the planetary gear sets PS1, PS2. This yields the advantage that there is no spatial conflict with the planetary gear sets PS1, PS2. In FIG. 10, by comparison, the shift element 5, viewed axially, is arranged between the two planetary gear sets PS1, PS2 and the electric machine 1. This yields the advantage that the actuator or the shift element 5 and the engaging and disengaging connections of the shift element 5, in addition to the electric machine 1, are easier to access for the assembly process.

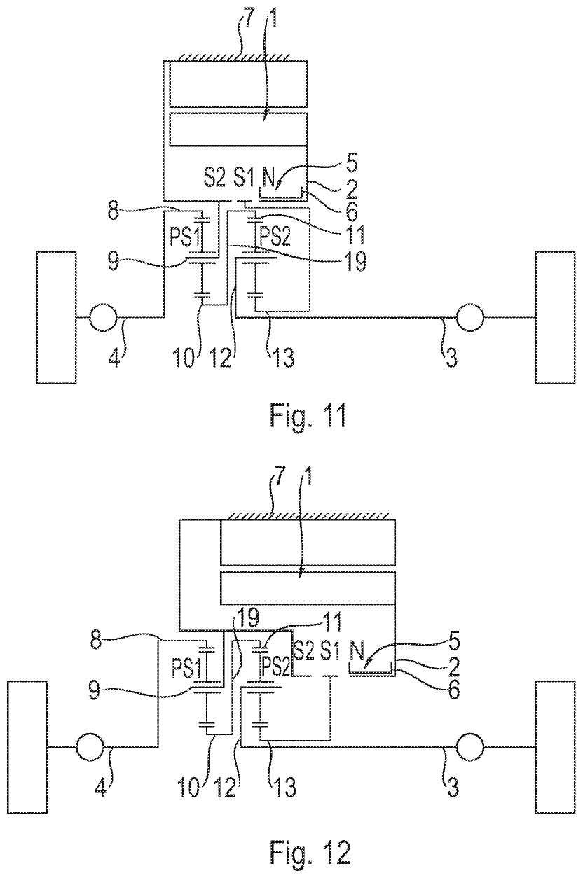

In FIGS. 11 and 12, the planetary gear sets PS1, PS2 are arranged axially next to each other. Furthermore, the planetary gear sets PS1, PS2 and the shift element 5 are arranged radially within the electric machine 1. In FIG. 11, the shift element 5, viewed radially, is arranged between the planetary gear sets PS1, PS2 and the electric machine 1. By comparison, in FIG. 12, the shift element 5 is arranged axially next to the two planetary gear sets PS1, PS2. This yields a very compact axial design. The shift element 5 can therefore be optimally integrated into the installation space of the electric machine 1. When the two planetary gear sets PS1, PS2 are arranged axially next to each other, the sun gear 10 of the first planetary gear set PS1 and the ring gear 11 of the second planetary gear set PS2 are connected to each other, for example, via a coupling shaft 19.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 electric machine
2 rotor shaft or drive shaft
3 first output shaft
4 second output shaft
5 shift element or actuator
6 sliding sleeve
7 housing or stator
8 ring gear of the first planetary gear set
9 planet carrier of the first planetary gear set
10 sun gear of the first planetary gear set
11 ring gear of the second planetary gear set
12 planet carrier of the second planetary gear set
13 sun gear of the second planetary gear set
14 spindle drive
15 selector fork
16 parking pawl
17 locking element
18 electric motor
19 coupling shaft
N first shift position
S1 second shift position
S2 third shift position
PS1 first planetary gear set
PS2 second planetary gear set

1-14. (canceled)

15. An electric drive for a vehicle, comprising:
at least one electric machine (1) with a rotor shaft (2) as a drive shaft;
a transmission connected to a first output shaft (3) and a second output shaft (4); and
a shift element (5) with at least one actuatable coupling element for implementing a first shift position (N), a second shift position (S2) and a third shift position (S2),
wherein, in the first shift position (N), the coupling element is connected either to an element of the transmission or to the rotor shaft (2),
wherein, in the second shift position (S1), the element of the transmission is connected to the rotor shaft (2) via the coupling element, and
wherein, in the third shift position (S2), the element of the transmission and the rotor shaft (2) are connected to a housing via the coupling element.

16. The electric drive of claim 15, further comprising an axially displaceable sliding sleeve (6) provided as a coupling element, the axially displaceable sliding sleeve (6) movable by a selector fork (15) into the first, second, and third shift positions (N, S1, S2) that are situated sequentially in an axial direction, the selector fork (15) actuatable via a spindle drive (14).

17. The electric drive of claim 15, wherein the rotor shaft (2), the transmission, and the first and second output shafts (3, 4) are arranged coaxially.

18. The electric drive of claim 15, wherein the transmission comprises a first planetary gear set (PS1) and a second planetary gear set (PS2), the first and second planetary gear sets coupled to each other such that torque introduced via the rotor shaft (2) is splittable onto the first output shaft (3) and the second output shaft (4) via the first and second planetary gear sets (PS1, PS2).

19. The electric drive of claim 18, wherein:
a ring gear (8) of the first planetary gear set (PS1) is connected to the second output shaft (4);
a planet carrier (9) of the first planetary gear set (PS1) is connected to the housing (7);
a sun gear (10) of the first planetary gear set (PS1) is connected to a ring gear (11) of the second planetary gear set (PS2);
a planet carrier (12) of the second planetary gear set (PS2) is connected to the first output shaft (3); and
a sun gear (13) of the second planetary gear set (PS2) is connectable via the shift element (5) to the rotor shaft (2) in the second shift position (S1) or to the rotor shaft (2) and to the housing (7) in the third shift position (S2).

20. The electric drive of claim 18, wherein the first and second planetary gear sets (PS1, PS2) are radially nested.

21. The electric drive of claim 20, wherein the first and second planetary gear sets (PS1, PS2) are arranged axially next to the electric machine (1).

22. The electric drive of claim 20, wherein the shift element (5) is arranged on a side of the electric machine (1) facing away from the first and second planetary gear sets (PS1, PS2).

23. The electric drive of claim 20, wherein the shift element (5) is arranged between the electric machine (1) and the first and second planetary gear sets (PS1, PS2).

24. The electric drive of claim 18, wherein the first and second planetary gear sets (PS1, PS2) are arranged axially next to each other.

25. The electric drive of claim 24, wherein the first and second planetary gear sets (PS1, PS2) are arranged radially within the electric machine (1).

26. The electric drive of claim 24, wherein the shift element (5) is arranged radially within the electric machine (1).

27. The electric drive of claim 24, wherein the shift element (5) is arranged radially between the electric machine (1) and at least one of the first and second planetary gear sets (PS1, PS2) or axially next to the first and second planetary gear sets (PS1, PS2).

28. A vehicle, comprising at least one electric drive of claim 15.
